(19) United States
(12) Patent Application Publication
(10) Pub. No.: US 2014/0345338 A1
(43) Pub. Date: Nov. 27, 2014

(54) ANTI-THEFT DEVICE FOR A STEERING COLUMN OF A MOTOR VEHICLE AND METHOD FOR THE ASSEMBLY THEREOF

(71) Applicant: VALEO SECURITE HABITACLE, Creteil (FR)

(72) Inventors: Alix Della Fiorentina, Nevers (FR); Christophe Perrin, Nevers (FR); Patrice Poggi, Nevers (FR)

(21) Appl. No.: 14/365,912

(22) PCT Filed: Dec. 20, 2012
(86) PCT No.: PCT/EP2012/076435

§ 371 Date: Jun. 16, 2014

(30) Foreign Application Priority Data
Dec. 21, 2011 (FR) 11/03987

(51) Int. Cl. E05B 77/44

(52) U.S. Cl. CPC E05B 77/44
USPC 70/253; 29/428; 29/525.01

(57) ABSTRACT

The present invention relates to an anti-theft device (13) for a steering column (19) of a motor vehicle comprising: •an anti-theft body (15), •a locking module (23) intended to be received in a blind housing of the anti-theft body (15), said locking module (23) being configured in such a way as to lock the steering column (19) in the lockout position and to leave said steering colunm (19) released in the unlocked position, •an additional reinforcing device (43) being interposed between the wall forming the bottom of the blind housing and the locking module (23).

The present invention relates to the field of anti-theft locks for steering columns and finds a particularly advantageous application in the field of motor vehicles.

One of the problems of anti-theft locks for steering columns according to the prior art is the vulnerability thereof in relation to malicious attacks intended to unlock the anti-theft lock.

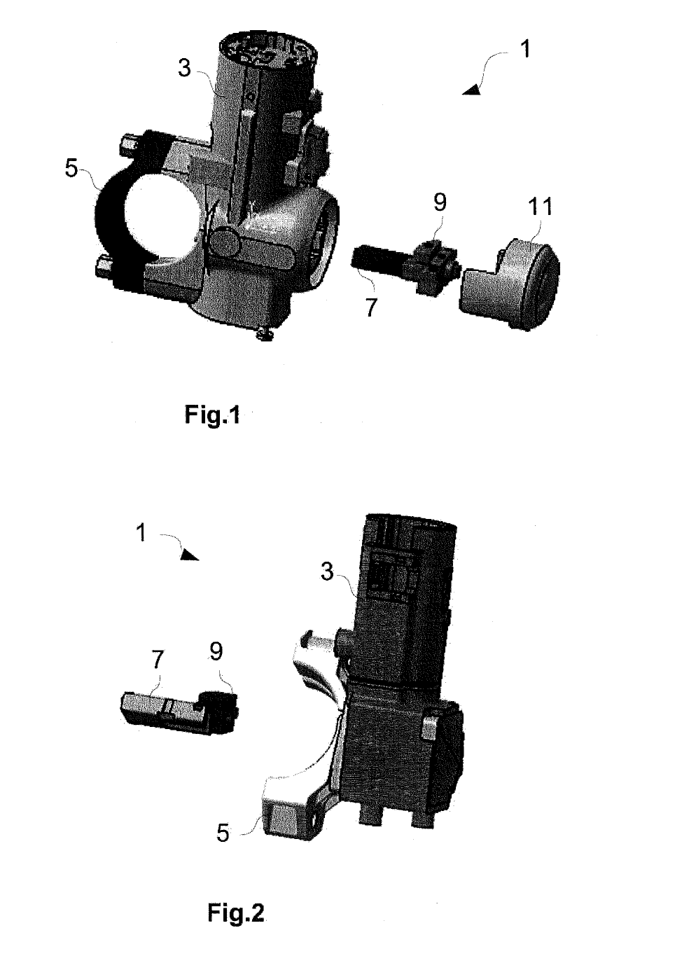

FIGS. 1 and 2 represent two examples of anti-theft locks 1 according to the prior art each comprising an anti-theft lock body 3 comprising a clamping collar 5 intended to secure the anti-theft lock 1 on the steering column (not shown). The anti-theft locks 1 also comprise a bolt 7 movably mounted in the anti-theft lock body 3, between an unlocked position wherein it is intended to be arranged away from the steering column and a locked position wherein it is intended to lock said column. The bolt 7 belongs to a locking module also comprising a slide 9. The bolt 7 is actuated by the slide 9, in turn moved by means of a rotary lock (not shown) integrated in the anti-theft lock.

FIG. 1 corresponds to an embodiment wherein assembly is performed via the side opposite the steering column and wherein a steel closing plate 11 protects the access to the bolt 7. However, in this embodiment, the closing plate 11 is visible and accessible such that it is relatively easy for an aggressor to remove the plate 11, for example by levering with a screwdriver.

FIG. 2 corresponds to an embodiment wherein assembly is performed on the side of the steering column such that the exterior of the anti-theft lock body 3 is formed from a single piece and renders the location of the bolt 7 undetectable. However, the anti-theft lock body 3 is generally made from a material having a limited resistance such that an aggressor could also access the bolt, using for example a screwdriver, to break the anti-theft lock body 3.

It thus appears to be necessary to provide an anti-theft lock for a steering column of a motor vehicle which is economical and has little or no sensitivity to attempted forcible entry by a potential aggressor.

The present invention thus relates to an anti-theft lock for a steering column of a motor vehicle comprising:

an anti-theft lock body,

a locking module intended to be received in a blind housing of the anti-theft lock body, said locking module being configured in such a way as to lock the steering column in the locked position and to release said steering column in the unlocked position, characterised in that an additional reinforcing device is inserted between the wall forming the bottom of the blind housing and the locking module.

The anti-theft lock device according to the present invention presents difficult or even impossible access to the locking module, particularly to the bolt, from outside the steering column.

Indeed, the reinforcing device is inserted between the locking module and the blind housing in such a way that the locking module is only accessible after removing the reinforcing device.

The design of said anti-theft lock enables quick assembly, which is thus less costly than that of the prior art.

Furthermore, it is possible to limit the thickness of the anti-theft lock body at the blind housing, making it possible to limit the production costs of said anti-theft lock body.

The anti-theft lock according to the present invention thus simply, effectively and economically has little or no sensitivity to attempted forcible entry by a potential aggressor.

According to one or more features of the anti-theft lock according to the invention, taken alone or in combination:

the reinforcing device is a reinforcing plate,

the reinforcing plate has a surface area substantially equal to the surface area of the wall forming the bottom of the housing,

the reinforcing plate is made from a metallic material, particularly from steel,

the reinforcing plate has a thickness between 1.5 and 2 mm,

the locking module comprises:
a bolt movably mounted between an unlocked position wherein it is intended to be arranged away from the steering column, and a locked position wherein it is intended to lock said steering column, p1 a slide for actuating the bolt suitable for moving the bolt to the locked or unlocked position,
a bolt guide comprising a first and second open end wherein the bolt and the slide are movably mounted in translation to enable the bolt to protrude, in the locked position, through the first open end of the bolt guide,
means for elastic return of the bolt to the locked position wherein a first end is in contact with the slide,

and the reinforcing device substantially sealing the second open end of the bolt guide, said reinforcing device being in contact with a second end of the elastic return means of the bolt,

the bolt guide comprises a peripheral shoulder on the second open end thereof to enable the positioning of the reinforcing device,

the reinforcing device is secured to the bolt guide by means of force-fitted assembly or by crimping,

the locking module is secured to the anti-theft lock body by means of a force-fitted assembly wherein the reinforcing device bears on the bottom of the blind housing of the anti-theft lock body,

the anti-theft lock body is made from Zamak® or from plastic.

According to a further aspect, the invention relates to a method for assembling an anti-theft lock comprising the following steps:

assembling the elements forming the locking module,

securing the reinforcing device on one end of the locking module so as to form a locking unit,

inserting said locking unit into the blind housing of the anti-theft lock body.

Advantageously, to form the locking module, the bolt, slide and elastic return means are respectively inserted in the bolt guide via the second open end.

Advantageously, the reinforcing device is secured on the second open end of the bolt guide.

Advantageously, the assembly of a locking unit comprising a locking module and a reinforcing device comprises the following steps:

positioning the elastic return means in a housing assigned for the slide,

assembling the bolt and the slide equipped with the elastic return means,

inserting the bolt and slide assembly equipped with the elastic return means into the bolt guide,

securing, by means of force-fitting, the reinforcing device on the second end of the bolt guide.

The method according to the present invention comprises a step wherein a single locking unit consisting of the locking module and the reinforcing device is formed.

The method for assembling the anti-theft lock is thus simple to implement and economical in that said unit formed is assembled in the anti-theft lock body.

Further advantages and features will emerge on reading the description of the invention, and in the appended figures representing a non-limiting example of an embodiment and wherein:

FIG. 1 represents an exploded view of a first embodiment of an anti-theft lock according to the prior art,

FIG. 2 represents an exploded view of a second embodiment of an anti-theft lock according to the prior art,

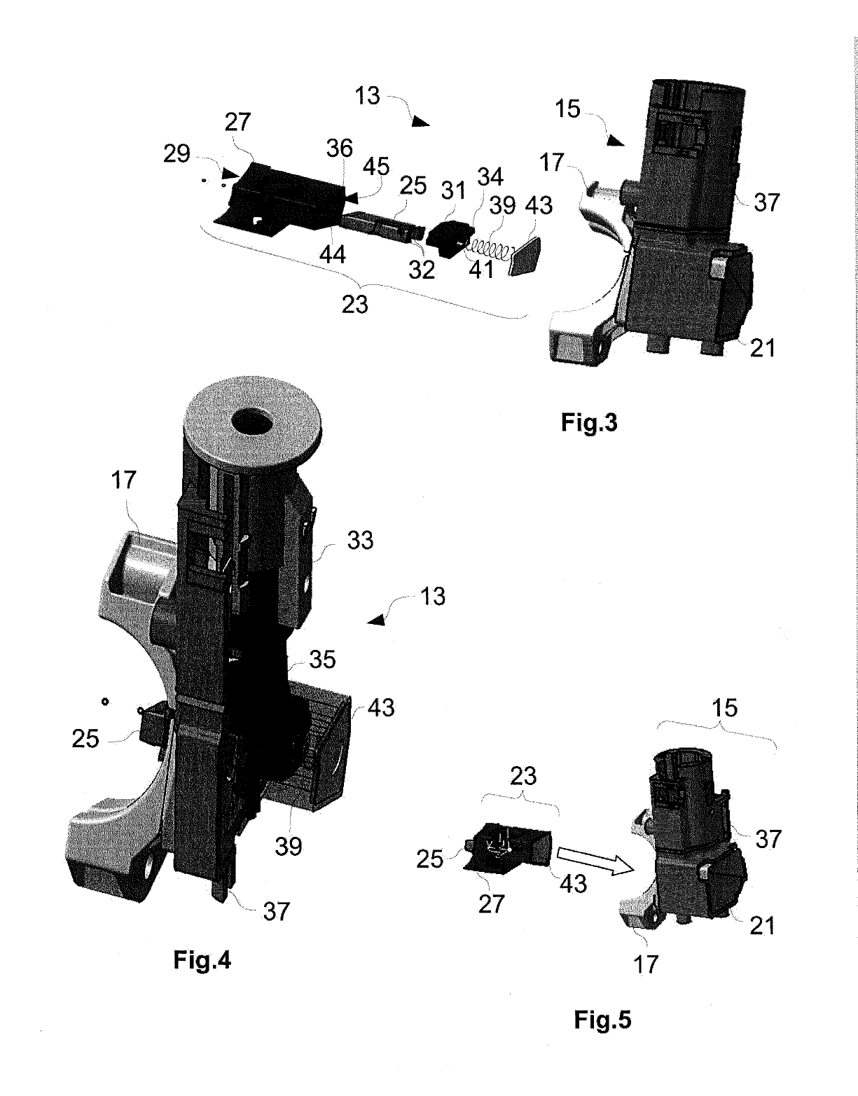

FIG. 3 represents an exploded view of an anti-theft lock according to one embodiment of the present invention,

FIG. 4 represents an assembled view of an anti-theft lock according to one embodiment of the present invention wherein the anti-theft lock is shown partially,

FIG. 5 represents an assembled view of a locking module of an anti-theft lock according to one embodiment of the present invention and the assembly thereof on the anti-theft lock,

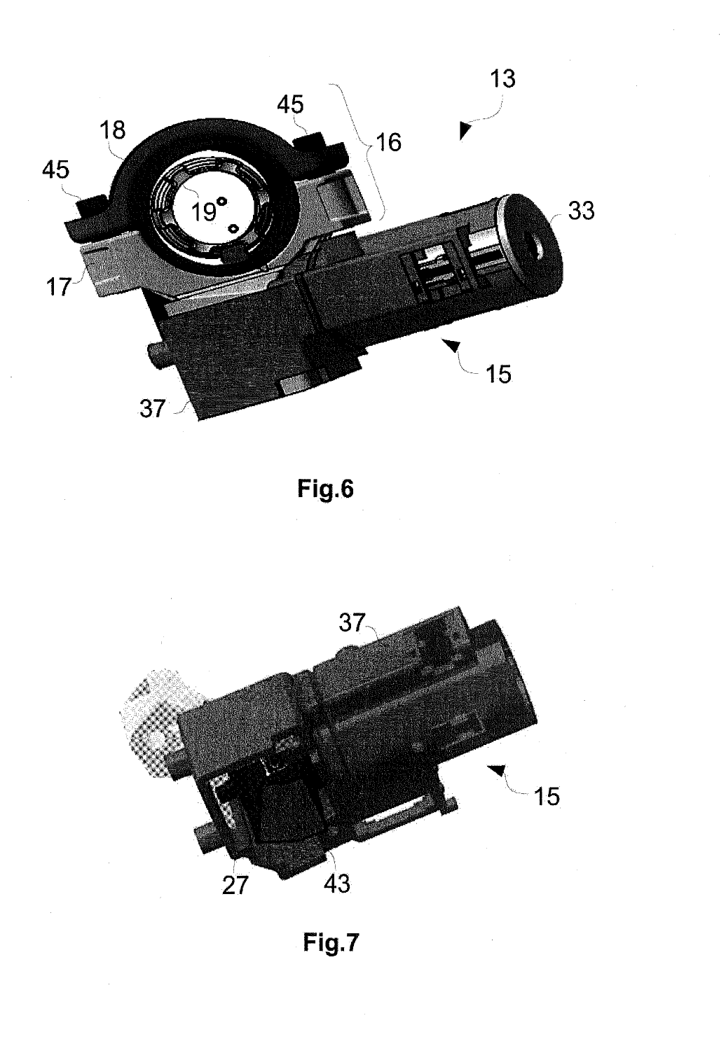

FIG. 6 represents a top view of an anti-theft lock according to one embodiment of the present invention when the anti-theft lock is mounted on the steering column,

FIG. 7 represents an assembled view of an anti-theft lock according to one embodiment of the present invention and wherein the locking module can be made out in a transparent view.

In these figures, identical elements bear the same reference numbers.

FIGS. 3 to 7 illustrate an example of an embodiment of an anti-theft lock 13 for a steering column 19 of a motor vehicle.

The anti-theft lock 13 comprises an anti-theft lock 15 equipped with a clamping collar 16 having a first 17 and a second 18 half-collar designed to be assembled about a steering column 19 (FIG. 6). The first half-collar 17 is integrated in a first part 21 of the anti-theft lock 15 comprising a blind housing intended to receive a locking module 23. The first part 21 of the anti-theft lock 15 is for example made of “Zamak®” so as to have a good mechanical resistance in position on the column 19. Alternatively, the first part 21 of the anti-theft lock 15 is made from plastic.

The locking module 23 comprises a bolt 25 slidably mounted in the first part 21 of the anti-theft lock body 15, via a bolt guide 27 of the locking module (FIG. 3), between an unlocked position wherein it is in the retracted position in the bolt guide 27, away from the steering column 19 and a locked position wherein it is intended to lock the column 19 while protruding from a first open end 29 of the bolt guide 27 and the first half-collar 17 to engage conventionally by nesting with an element of the steering column as shown in FIG. 6. The locking module 23 further comprises a slide 31 for actuating the bolt 25 moving the bolt 25 to the locked or unlocked position. The actuating slide 31 is controlled by the rotation of a lock rotor 33 via a cam 35 (FIG. 4).

The lock 33 is intended to be inserted and secured inside a second part 37 of the anti-theft lock body 15, for example made from “Zamak®” or from plastic, partially covering the first part 21 of the anti-theft lock body 15. Furthermore, it should be noted that the anti-theft lock body 15 may also consist of a single piece including the first 21 and the second 37 parts.

Furthermore, the locking module 23 also comprises means 39 for the elastic return of the bolt 25 to the locked position. These elastic return means 39 are, for example a helical, straight or conical type spring, which is positioned in a housing 41 provided in the actuating slide 31. The housing 41 comprises for example a protuberance suitable for holding the spring in position in the housing 41.

An additional reinforcing device is inserted between the wall forming the bottom of the blind housing and the locking module 23. The reinforcing device may be in the form of a reinforcing plate 43, as illustrated in the examples. The reinforcing plate 43 may have a surface area substantially equal to the surface area of the wall forming the bottom of the housing. The reinforcing plate 43 may be made from a metallic material, particularly steel, making it possible to increase the sturdiness of the reinforcing device.

The reinforcing device, in particular the reinforcing plate 43, is for example force-fitted or crimped in a peripheral shoulder 44 of the second open end 45 of the bolt guide 27. Force-fitting consists of an assembly wherein force applied enables the reinforcing device 43 to be inserted into a housing of the bolt guide 27 having a slightly smaller size. This smaller size may be obtained by means of a peripheral protuberance which also makes it possible to hold the reinforcing device 43 in place once force-fitting has been performed. Crimping consisting of a deformation of the bolt guide 27 once the reinforcing device 43 is in position, for example in the peripheral shoulder 44, so as to lock the reinforcing device 43 in said peripheral shoulder 44. Alternatively, the reinforcing device 43 may be screwed or pinned. The reinforcing device 43 has a thickness between 1.5 and 2 mm so as to provide sufficient resistance while limiting the thickness of the anti-theft lock 13. Furthermore, the reinforcing device 43 compresses the spring 39 which is then pre-stressed between the reinforcing device 43 and the actuating slide 31 as shown in a transparent view in FIG. 4.

According to the embodiment shown in the figures, during the assembly of the anti-theft lock 13, the formation of the locking module 23 comprises the positioning of the elastic return means 39 in the assigned housing 41 provided in the actuating slide 31.

The slide 31 equipped with the elastic return means 39 is then assembled with the bolt 25. For example, said assembly is performed by means of catches 32 and complementary hooking means (not shown) of the slide 31. The assembly obtained is inserted into the bolt guide 27 via the second open end 45 as shown in FIG. 3. The slide 31 comprises, for example, a pin 34 engaging with a groove 36 of the bolt guide 27 to guide the slide 31 in translation in the bolt guide 27. The second open end 45 of the bolt guide 27 is then sealed with the reinforcing device, particularly the reinforcing plate 43, which compresses the elastic return means 39 against the slide 31. The reinforcing device, particularly the reinforcing plate 43, is secured by force-fitting or by crimping. Indeed, a mere attachment is sufficient since, once mounted on the anti-theft lock body 15, the reinforcing device 43 presses on the bottom of the blind housing of the anti-theft lock 15, thus rendering any movement of the reinforcing device 43 impossible. Once assembled, the locking module 23 and the reinforcing device 43 form a locking unit suitable for easy handling such that the step for assembling the locking unit may be performed at any time and at different locations to the other steps for assembling the anti-theft lock 13.

A second step consists of assembling the locking unit onto the anti-theft lock 15 as shown in FIG. 5. The reinforcing device 43 abuts against the bottom of the blind housing as shown in a transparent view in FIG. 7 and is clamped in the blind housing of the anti-theft body 15 such that the anti-theft lock body 15 can be handled easily during the subsequent steps for assembling the anti-theft lock 13.

A third step consists of mounting the cam 35 and the lock 33 on the anti-theft lock body 15 to engage with the locking unit and control the movement of the bolt 25 (FIG. 4). If the anti-theft lock body 15 comprises two parts, the first 21 and the second 37 parts are pre-assembled to enable the mounting of the cam 35 on the slide 31.

To mount onto the steering column 19, the first 17 and the second 18 half-collars are positioned on either side of the steering column 19 and are clamped on the steering column 19 by means of two screws 45 as shown in FIG. 6.

When the anti-theft lock 13 is assembled, the exterior of the anti-theft lock body 15 appears as a solid unit, rendering the exact location of the bolt 25 undetectable. Furthermore, in the event of an attack, for example with a screwdriver, at the first part 21 of the anti-theft lock body 15, if the aggressor succeeds in piercing the anti-theft lock body made from “Zamak®”, said aggressor abuts against the steel reinforcing device 43 which is much more resistant. In this way, with this anti-theft lock design, the aggressor needs to cut a large area of the anti-theft lock body to be able to dismantle the reinforcing device 43 and access the bolt 25. The time required to access the bolt 25 is then much longer which deters the aggressor.

In particular, the use of a reinforcing device in the form of a steel reinforcing plate 43 mounted on the bolt guide 27 makes it possible to render access to the bolt 25 more difficult for an aggressor while facilitating the assembly of the anti-theft lock 13, reducing the time required for assembly on the production line. Furthermore, the presence of the reinforcing plate 43 makes it possible to reduce the thickness of the anti-theft lock body 15 since the anti-theft lock body 15 no longer acts as protection of the bolt 25 thus making it possible to reduce the amount of material required for the anti-theft lock body 15 and the space required under the steering wheel.

Key to the figures

| | |
|---|---|
| Etat de la technique | Prior art |

1. An anti-theft lock for a steering column of a motor vehicle comprising:
an anti-theft lock body;
a locking module intended to be received in a blind housing of the anti-theft lock body, said locking module being configured in such a way as to lock the steering column in the locked position and to release said steering column in the unlocked position, wherein
an additional reinforcing device is inserted between the wall forming the bottom of the blind housing and the locking module.

2. The anti-theft lock of claim 1, wherein the reinforcing device is a reinforcing plate.

3. The anti-theft lock of claim 2, wherein the reinforcing plate has a surface area substantially equal to the surface area of the wall forming the bottom of the housing.

4. The anti-theft lock of claim 2, wherein the reinforcing plate is made from steel.

5. The anti-theft lock of claim 2, wherein the reinforcing plate has a thickness between 1.5 and 2 mm.

6. An anti-theft device according to claim 1, wherein the locking module comprises:
a bolt movably mounted between an unlocked position wherein the bolt is arranged away from the steering column, and a locked position wherein it is intended to lock said steering column,
a slide for actuating the bolt suitable for moving the bolt to the locked or unlocked position,
a bolt guide comprising a first and second open end wherein the bolt and the slide are movably mounted in translation to enable the bolt to protrude, in the locked position, through the first open end of the bolt guide,
means for elastic return of the bolt to the locked position wherein a first end is in contact with the slide,
and the reinforcing device substantially sealing the second open end of the bolt guide, said reinforcing device being in contact with a second end of the elastic return means of the bolt.

7. The anti-theft lock of claim 6, wherein the bolt guide comprises a peripheral shoulder on the second open end thereof to enable the positioning of the reinforcing device.

8. The anti-theft lock of claim 6, wherein the reinforcing device is secured to the bolt guide by means of force-fitted assembly or by crimping.

9. The anti-theft lock of claim 1, wherein the locking module is secured to the anti-theft lock body by means of a force-fitted assembly wherein the reinforcing device bears on the bottom of the blind housing of the anti-theft lock body.

10. The anti-theft lock of claim 1, wherein the anti-theft lock body is made from Zamak® or from plastic.

11. A method for assembling an anti-theft lock comprising:
assembling the elements forming the locking module;
securing the reinforcing device on one end of the locking module so as to form a locking unit; and
inserting said locking unit into the blind housing of the anti-theft lock body.

12. The method according to claim 11 wherein, to form the locking module, the bolt, slide and elastic return means are respectively inserted in the bolt guide via the second open end.

13. The method according to claim 12, a wherein the reinforcing device is secured on the second open end of the bolt guide.

14. The method according to claim 12, wherein the assembly of a locking unit comprising a locking module and a reinforcing device comprises the following steps:
positioning the elastic return means in a housing assigned for the slide;
assembling the bolt and the slide equipped with the elastic return means;
inserting the bolt and slide assembly equipped with the elastic return means into the bolt guide,
securing by means of force-fitting the reinforcing device on the second end of the bolt guide.
